(19) United States
(12) Patent Application Publication
(10) Pub. No.: US 2024/0369247 A1
(43) Pub. Date: Nov. 7, 2024

(54) OPTIMIZATION ENGINE FOR ENERGY SUSTAINABILITY

(71) Applicant: Target Brands, Inc., Minneapolis, MN (US)

(72) Inventors: NIKITA KATYAL, Bengaluru (IN); BHARATH RANGARAJAN, Minneapolis, MN (US); SOURAV DAS, San Francisco, CA (US); JAY GAYNOR, Pittsburgh, PA (US); MATTHEW JOHNSON, Minneapolis, MN (US); ARVINDH ARUL, Plano, TX (US); SOMYI BAEK, New York, NY (US); MANJU PANDIT, Bengaluru (IN); SOUMOJIT KUMAR, Minneapolis, MN (US)

(21) Appl. No.: 18/771,862

(22) Filed: Jul. 12, 2024

Related U.S. Application Data
(63) Continuation-in-part of application No. 17/752,240, filed on May 24, 2022, now Pat. No. 12,038,189.
Application No. 17/752,240 is a continuation of application No. 16/505,315, filed on Jul. 8, 2019, now Pat. No. 11,371,737.

(51) Int. Cl. F24F 11/47; F24F 11/64; F24F 11/65; F24F 140/50; F24F 140/60; G05B 19/042

(52) U.S. Cl. CPC F24F 11/47; F24F 11/64; F24F 11/65; G05B 19/042; F24F 2140/50; F24F 2140/60; G05B 2219/2639

(57) ABSTRACT

A method for reducing electrical costs relating to conditioning air in a building with an air handling unit, the method comprising: identifying a starting hour and a corresponding starting temperature; identifying an ending hour and a corresponding ending temperature; identifying a plurality of time increments between the starting hour and the ending hour; for each of the plurality of time increments, identifying a plurality of temperature setpoint nodes; determining a least cost pathway from the starting temperature at the start hour to the ending temperature at the ending hour across the plurality of temperature setpoint nodes; publishing a temperature setpoint schedule for each time increment based on the temperature setpoint nodes included in the least cost pathway; and operating the air handling unit from the starting hour to the ending hour based on the published temperature setpoint schedule.

### RELATED APPLICATION

This application claims priority to and is a continuation-in-part of U.S. patent application Ser. No. 17/752,240, filed on May 24, 2022 which is a continuation of U.S. patent application Ser. No. 16/505,316, filed on Jul. 8, 2019 and now issued as U.S. Pat. No. 11,371,737. The entireties of the U.S. Pat. Nos. '240 and '737 applications are incorporated by reference herein.

### TECHNICAL FIELD

The present disclosure relates generally to methods and systems for reducing the peak electrical demand load of a building. More particularly, the present disclosure describes a method by which the operation of selected air conditioning systems can be modeled and subsequently controlled to limit peak electrical consumption.

### BACKGROUND

Electrical utilities provide power to a wide variety of end users, and have various pricing structures for different types of end users. Commercial and institutional facilities are commonly billed by the electrical utility for both the total usage of electricity over a billing period and are additionally charged a rate based on the maximum peak electrical demand used by the facility during the billing period. The former charge is generally referred to as a usage charge and is typically calculated by multiplying a usage rate by the total number of kilowatt-hours (kWh) consumed within the billing period. The latter charge is generally referred to as a peak demand charge and is typically calculated by multiplying a peak demand rate by the peak electrical demand kilowatts. While pricing structures of this type vary, the peak demand charges in some applications can be half or more of the electrical power bill. As electrical power bills represent a large expense for end users, strategies for reducing such expenses are desirable.

### SUMMARY

A method for reducing electrical costs relating to conditioning air in a building with an air handling unit, the method comprising: identifying a starting hour and a corresponding starting temperature; identifying an ending hour and a corresponding ending temperature; identifying a plurality of time increments between the starting hour and the ending hour; for each of the plurality of time increments, identifying a plurality of temperature setpoint nodes; determining a least cost pathway from the starting temperature at the start hour to the ending temperature at the ending hour across the plurality of temperature setpoint nodes; publishing a temperature setpoint schedule for each time increment based on the temperature setpoint nodes included in the least cost pathway; and operating the air handling unit from the starting hour to the ending hour based on the published temperature setpoint schedule.

In summary, the present disclosure relates to methods and systems for reducing peak electrical demand costs for a building, such as a retail store. The disclosure presents an approach the enables a building owner or operator to reduce the building peak electrical demand on a given day without requiring direct control over compressors or other equipment associated with the HVAC system. Safe and effective operation of such equipment can require a great deal expertise that is typically not within the skill set of building owners and operators. With the disclosed method, a policy can be generated from a model and pushed out to the building automation system and/or individual air handling units that temporarily changes the set points associated with the HVAC system to indirectly control the operation of the compressors. In this way, any building owner or operator can realize utility savings without necessitating the further implementation of highly complex controls. In one example, the policy can be structured to initially lower the set points of the selected equipment during a precooling period such that the building zone temperatures are initially reduced, return the set points to their normal settings during a drift period to allow the building zone temperatures to come back to their normal temperatures, and then raise the set points to above their normal settings during a curtailment period to allow the building zone temperatures to increase and thus lower the demand load on the cooling equipment. Accordingly, in some implementations peak electrical demand can be managed by only changing temperature set points of selected equipment over selected time periods without requiring detailed control over other operational parameters.

In one implementation, a method for reducing peak electrical demand of a building is disclosed including the steps of generating a baseline electrical demand profile over a target time period from a model, identifying a maximum peak demand value from the baseline electrical demand profile, calculating first and second reference peak value from the maximum peak demand value, defining a policy including a peak management period based on the first and second reference peak values, the peak management period including at least a first sub-period and a subsequent second sub-period, the first sub-period having a first temperature set point for at least one air handling system of the building that is different from a normal operating temperature set point, the second sub-period having a second temperature set point different from both the normal operating temperature set point and the first temperature set point, and implementing the policy.

In some examples, the first sub-period is a pre-cooling period and the first temperature set point is below the normal operating temperature set point.

In some examples, the second sub-period is a curtailment period and the second temperature set point is above the normal operating temperature set point.

In some examples, the peak management period includes a third sub-period sequentially between the first and second sub-periods.

In some examples, the third sub-period is a drift period having a third set point equaling then normal operating temperature set point.

In some examples, the target time period is a 24-hour period.

In some examples, the method further includes the step of verifying that the maximum peak demand value is greater than a peak demand-to-date value within a demand billing cycle.

In some examples, the method further includes the step of collecting performance data relating to implementing the policy.

In some examples, the first reference peak value is a predetermined value.

In some examples, the first reference peak value is between about 75 percent and about 95 percent of the maximum peak demand value.

In some examples, the first reference peak value is about 90 percent of the maximum peak demand value.

In some examples, the second reference peak value is a predetermined value.

In some examples, one or both of a starting time and an ending time of the pre-cooling period is a function of a first intersection between the baseline electrical demand profile and the second reference peak value.

In some examples, the pre-cooling period ends at the first intersection between the baseline electrical demand profile and the second reference peak value.

In some examples, the starting time of the curtailment period coincides with a time at which the maximum peak demand value occurs.

In some examples, the ending time of the curtailment period is a function of a second intersection between the baseline electrical demand profile and the second reference peak value.

In some examples, the curtailment period ends at the second intersection between the baseline electrical demand profile and the second reference peak value.

A method for reducing peak electrical demand of a building is disclosed. The method can include generating a baseline electrical demand profile over a target time period from a model, defining a policy including a peak management period based on the baseline electrical demand profile, the peak management period including at least a first sub-period and a subsequent second sub-period, the first sub-period having a first temperature set point for at least one air handling system of the building that is different from a normal operating temperature set point, the second sub-period having a second temperature set point for the at least one air handling system different from both the normal operating temperature set point and the first temperature set point, and implementing the policy.

In some examples, the model is generated from one or more of historical electrical data for the building, weather forecast data, building operating schedules, equipment operating schedules, sales data, and data based on information received from a video camera located in the building.

In some examples, the method further includes collecting performance data during implementation of the policy and optimizing the model for subsequent generations of the baseline electrical demand profile.

In some examples, the model is generated from one or more of historical electrical data for the building, weather forecast data, building operating schedules, equipment operating schedules, sales data, and data based on information received from a video camera located in the building.

A method for reducing peak electrical demand of a building can include generating, prior to the beginning of a target time period, a baseline electrical demand profile over the target time period from a model, the baseline electrical demand profile being a prediction of electrical demand over the target time period using a normal operating temperature set point and using weather forecast data for the target time period; defining a policy including a peak management period based on the baseline electrical demand profile, the peak management period including at least a precooling period having a first temperature set point, a drift period having a second temperature set point different from the first temperature setpoint, and a curtailment period having a third temperature set point different from the first and second temperature setpoints; implementing the policy; collecting performance data during implementation of the policy; and optimizing the model for subsequent generations of the baseline electrical demand profile.

In some examples, the model is generated from one or more of historical electrical data for the building, weather forecast data, building operating schedules, equipment operating schedules, sales data, and data based on information received from a video camera located in the building.

In some examples, the target time period is a 24-hour period.

In some examples, for at least one of the pre-cooling, drift, and curtailment periods, the method further includes a least cost determination including: identifying a starting hour and a corresponding starting temperature; identifying an ending hour and a corresponding ending temperature; identifying a plurality of time increments between the starting hour and the ending hour; for each of the plurality of time increments, identifying a plurality of temperature setpoint nodes; determining a least cost pathway from the starting temperature at the start hour to the ending temperature at the ending hour across the plurality of temperature setpoint nodes; and publishing a temperature setpoint schedule for each time increment based on the temperature setpoint nodes included in the least cost pathway.

In some examples, the determining step includes calculating an energy consumption value from each of the setpoint nodes associated with one of the plurality of time increments to each of the setpoint nodes associated with the subsequent time increments.

In some examples, the determining step includes calculating an energy charge value from each of the setpoint nodes associated with one of the plurality of time increments to each of the setpoint nodes associated with the subsequent time increments.

In some examples, the least cost determination is performed for each of the precooling, drift, and curtailment periods.

A method for operating an air handling unit of a building over a time period can include determining whether to implement a peak management policy or to operate the air handling unit in a normal operating mode; based on the determination, identifying one or more time periods each including a starting temperature setpoint and starting time, an ending setpoint and ending time, and a plurality of intermediate temperature setpoints and associated implementation times; and updating a temperature setpoint setting of the air handling unit in accordance with a script based on the determination step.

In some examples, the plurality of intermediate temperature setpoints are determined by a least cost algorithm.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of an example modeling approach to develop a baseline electrical demand profile on a specified day for a building.

FIG. 2 illustrates a schematic diagram of an example process for generating a policy based on the model referenced in FIG. 1.

FIG. 3 illustrates a schematic diagram of an example process for implementing the policy referenced at FIG. 2.

FIG. 4 illustrates a schematic diagram of the results of implementing the policy referenced at FIG. 2 in comparison to the baseline electrical demand profile referenced at FIG. 1.

FIG. 5 is a schematic building zone layout for which the policy referenced in FIG. 2 may be implemented.

FIG. 6 illustrates a computing system usable to implement the processes described herein.

FIG. 7 illustrates a schematic diagram of an example process for reducing energy costs for a building.

FIG. 8 shows an example set of temperature and energy use calculations for an interior space associated with a building over time increments of one hour for a selected period of time.

FIG. 9 shows a visualization of a dynamic programming model that can be utilized with the example process shown in FIG. 7.

FIG. 10 shows a visualization of an example implementation of the dynamic programming model of FIG. 9 over a single time increment.

FIG. 11 shows a visualization of an example implementation of the dynamic programming model of FIG. 9 over multiple time increments.

FIG. 12 shows a visualization of a least cost path determined for an example implementation of the dynamic programming model of FIG. 9 over multiple time increments.

FIG. 13 shows a visualization of an example temperature setpoint schedule for a building throughout a 24-hour period.

FIG. 14 shows a visualization of an example temperature setpoint schedule using the dynamic programming model of FIG. 9.

FIG. 15 shows a visualization of an example temperature setpoint schedule using the peak management policy shown in FIG. 2.

FIG. 16 shows a visualization of an example temperature setpoint schedule using the peak management policy shown in FIG. 2 and the dynamic programming model of FIG. 9.

FIG. 17 shows a schematic of a data pipeline usable to aid in implementing the process of FIG. 7.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Model and Trained Model Process 1000

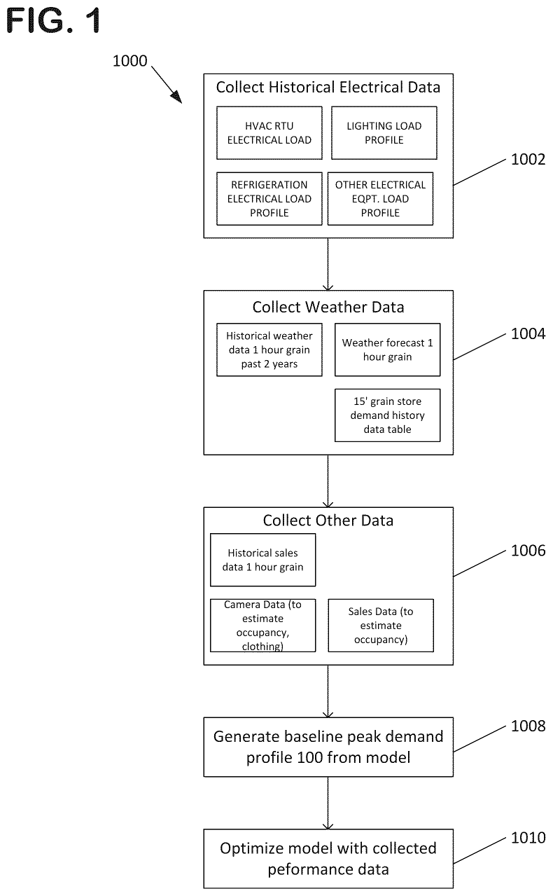

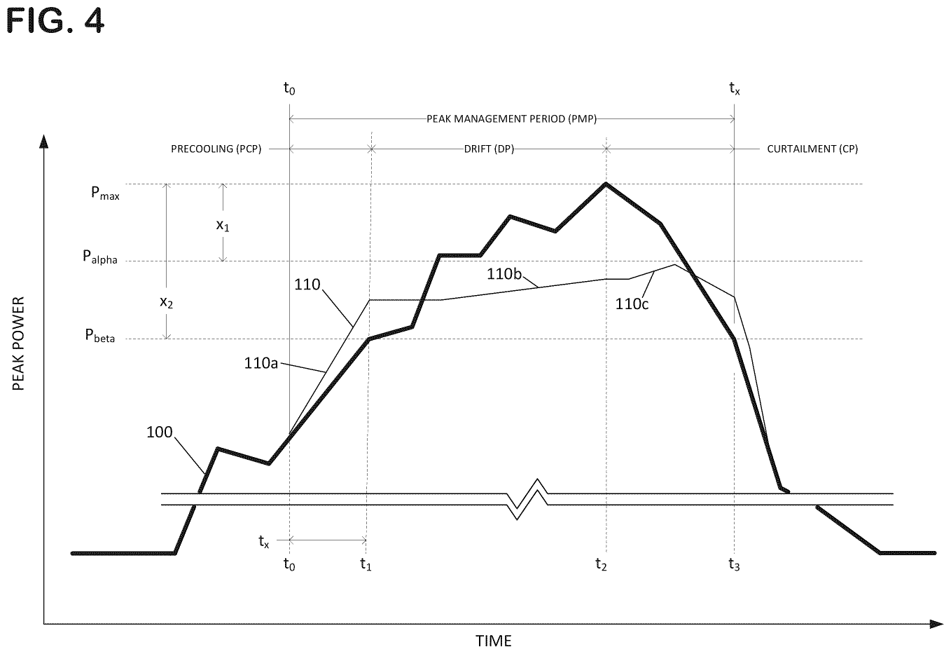

With reference to FIG. 1, a process 1000 is shown for creating a model and a trained model from which a baseline electrical demand profile 100 for an upcoming target day can be generated. Although other time periods can be used, a target day including a 24-hour period is described herein as most utility billing structures are based on the peak electrical demand occurring on a single day. A graphical depiction of an example baseline demand profile 100 is presented at FIG. 4. The baseline demand profile 100 is the time-based predicted electrical demand load profile for the building that would be expected to occur throughout the day without altering temperature set points associated with the cooling equipment of the HVAC system. For example, the profile 100 can include a discrete electrical demand value for any desired time increment (e.g., every 1 second, every 1 minute, every 5 minutes, every 15 minutes, every 30 minutes, every 1 hour, etc.). From the baseline demand profile 100, the maximum or peak electrical demand value P_{max-baseline} for the target day can also be identified as being the overall maximum electrical demand value.

In one aspect, the modelling process 1000 can be based on numerous variables and input data. For example, the model can include historical time series of energy consumption data 1102 in hourly frequency containing peak electrical demand and time of occurrence, the electrical demand one hour, two hours, and twenty four hours before the occurrence of the peak electrical demand, electrical demand associated with the HVAC system, electrical demand associated with refrigeration systems (e.g., freezers, coolers, etc.), electrical demand associated with lighting, and electrical demand associated with other building loads. This data can be further parsed and utilized to align with the parameters of the target day. For example, if the target day is a holiday, weekday, or a weekend day, the historical data set can be limited to include only the same type of days as the target day. Likewise, if the target day occurs within a given month, the historical data can be limited to days from that month and/or adjacent months.

The model can also be provided with historical and forward-looking or forecast data 1004 for the target day, such as outdoor dry bulb and wet bulb temperature, outdoor air dew point temperature, and outdoor air relative humidity over time. In one example, the historical electrical demand data set can also be limited to days that had generally similar weather as the forecast data indicates for the target day.

The model can also be provided with other types of data 1006. For example, the model can be provided with historical, real-time, or predicted sales-related data. Such data can be used to estimate building occupancy or traffic for the purpose of determining the associated internal heat gain of the building which can further enhance the performance of the model. For example, historical sales data on a similar day for which the baseline profile 100 is being created can be used to provide an enhanced estimation for hour-by-hour or even minute-by-minute occupancy. Real-time sales data could also be used as a proxy for building occupancy such that an updated or revised policy (discussed below) can be generated to account for any observed differences between the estimated occupancy load form historical or otherwise predicted data and the actual measured occupancy, as correlated through real-time sales data. The model can also be provided with historical or real-time video camera-related data. Such data can also be used to estimate building occupancy in the same manner as described above. Video camera-related data can also be used to assess the level of dress of the occupants, such that the temperature set points implemented during the peak management period (described below) can be optimized. For example, if occupants are relatively heavily dressed (e.g., wearing long sleeved clothing, jackets, or coats), the temperature set points may be lowered without compromising occupant comfort.

In one example, the model calculates 24 hours (i.e., the target day) of energy consumption using selected historical data (e.g., data from the past six months) and the forecast weather data at a step 1008. The model can utilize the elastic net method which is a linear regression model with both L1 and L2 regularization techniques relating to the lasso and ridge methods. In one aspect, the model balances the ratio (11_ratio) of these regularizations and how much to penalize (alpha) depending on the error of prediction. The model performs random sampling of these hyperparameters from two specific distributions. In case of 11_ratio it is a uniform distribution from 0.01 to 0 and in case of alpha it is a uniform distribution from 0.001 to 0.1. From these hyperparameters the model generates the best fit curve using cross validation. Constraints are also put on the model to consider only positive parameters. This modelling approach has been used to generate baseline demand profiles 100 for five existing retail stores and compared to the actual measured peak demand power profiles for the buildings. The results of testing show that the generated baseline demand profiles 100 are 3.34% MAPE (mean absolute percentage error) of the actual measured peak demand power profiles. Accordingly, the disclosed modelling approach yields a baseline demand profile 100 that can be used to reasonably predict the energy demand profile for an upcoming target day for a building.

In one aspect, performance data relating to energy consumption during the target day can be recorded and then later utilized to train the model at step 1010 to iteratively improve the generation of the baseline demand profile 100.

### Policy Generation 1100

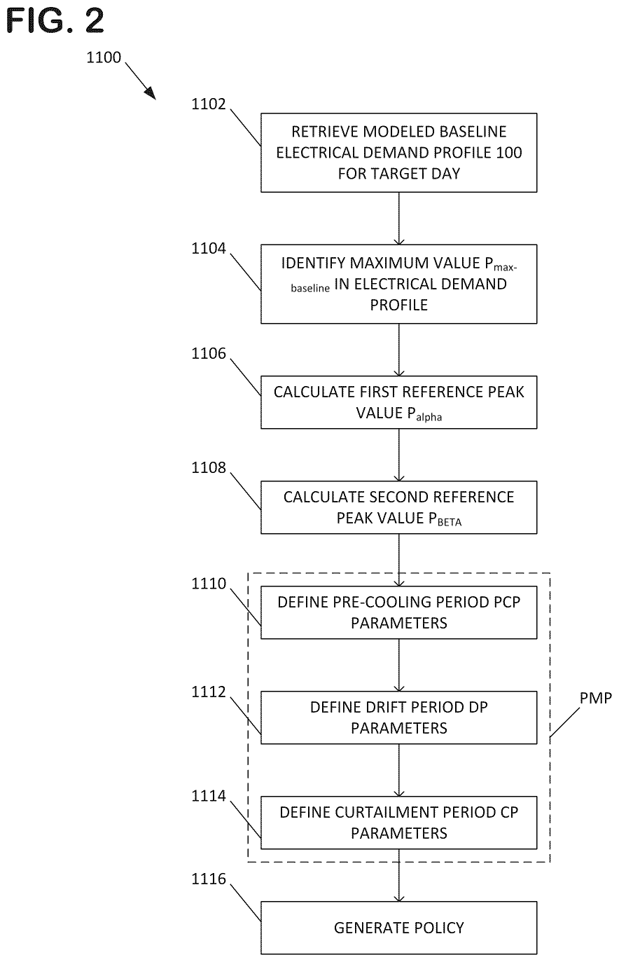

In one aspect, the policy can be generated by process 1100, shown at FIG. 2. In one aspect, the policy includes a set of instructions to temporarily alter the set points of selected cooling equipment of the HVAC system over different periods of time. The policy is implemented with the purpose of effectuating an actual electrical demand profile 110 having a reduced overall peak demand for the building, in comparison to the baseline electrical demand profile 100, on the day during which the policy is implemented, thus resulting in electrical demand savings. The actual demand profile 110 is the resulting demand profile that actually occurs after implementation of the policy.

As is discussed in more detail later, the policy can initially lower the set points of the selected equipment during a precooling period such that the building zone temperatures are initially reduced, return the set points to their normal settings during a drift period to allow the building zone temperatures to come back to their normal temperatures, and then raise the set points to above their normal settings during a curtailment period to allow the building zone temperatures to increase and thus lower the demand load on the cooling equipment. With such an approach, an electrical peak demand strategy can be implemented without requiring a building owner to directly control the individual HVAC system components (i.e., compressors) and also without requiring complex building energy modelling of the facility. The objective of the policy is to achieve an actual demand electrical profile 110 having a reduced overall peak demand in comparison to the predicted overall peak demand associated with the baseline demand profile.

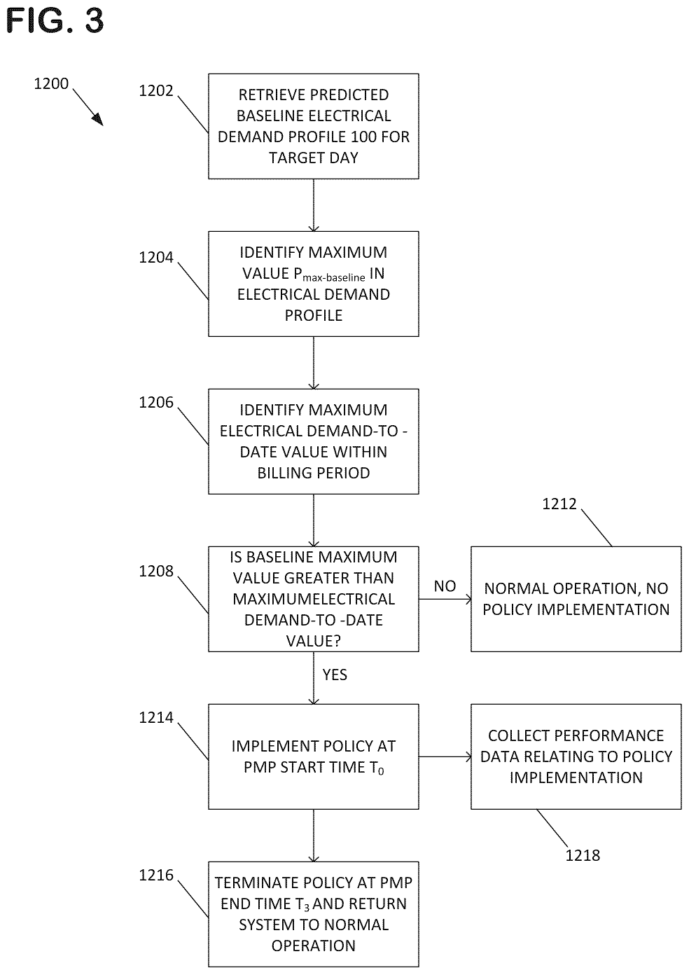

Referring to FIG. 3, the policy generation process 1100 can include retrieving the baseline electrical profile 100 at step 1102 and identifying the peak value P_{max-baseline} of the baseline demand profile 100 at step 1104. The baseline electrical demand profile 100, the actual electrical demand profile 110, and the following described parameters are graphically depicted at FIG. 4. At a step 1106, a first reference peak value Pₐₗₚₕₐ is identified which is defined by the peak value P_{max-baseline} minus a first increment x₁. In generalized terms, the first reference peak value Pₐₗₚₕₐ represents the desired maximum peak power that the building will actually reach during implementation of the policy. As such, if the policy is successful, the actual maximum peak power P_{max-actual} that the building reaches during implementation of the policy will be equal to or less than Pₐₗₚₕₐ. The first increment x₁ that defines the first reference peak value Pₐₗₚₕₐ may be established by a number of approaches. For example, x₁ can be set as a fixed value, can be set as a fraction or some other function of the peak value Pₘₐₓ, or via another method. In the example presented herein, the first increment x₁ is a fixed value set at 10 kW. Thus, on a day where the baseline demand profile predicts that the building will have a peak power value P_{max-baseline} of 400 kW, Pₐₗₚₕₐ would be established as 390 kW. In one aspect, the actual performance of the policy can be fed back into the trained model to optimize the selected value for the first increment x₁ for subsequent implementations of the policy.

In one aspect, the policy is implemented over a peak management period PMP that can be divided into multiple sub-periods, for example, a pre-cooling period PCP, a drift period DP, and a curtailment period CP. The parameters of the precooling period PCP, the drift period DP, and the curtailment period CP—including the below-discussed temperature set point values for each period, the magnitude of Pₐₗₚₕₐ and P_{beta}, and the points at which each period starts and ends—are selected such that the actual power profile 110 will not cross the first reference peak value Pₐₗₚₕₐ during the drift period DP. In some examples, the peak management period PMP does not include a drift period and proceeds directly from the pre-cooling period PCP to the curtailment period CP.

In the pre-cooling period PCP, selected components of the HVAC systems are controlled to lower the building temperature to a reduced pre-cooling set point T_{pc} that is below the normal operating temperature set point Tₙₒ. In the curtailment period, selected components of the HVAC systems are controlled to increase the building temperature to an increased set point T_{c} that is above the normal operating temperature set point Tₙₒ. In one example, the normal operating set point Tₙₒ may be about 74 degrees Fahrenheit (° F.) while the reduced pre-cooling set point T_{pc} may be set to about 72° F. and the increased curtailment set point T_{c} may be set to about 76° F. In operation, the pre-cooling period begins and ends prior to the time predicted at which the baseline demand profile 100 would reach the peak value P_{max-baseline} while the curtailment period occurs during the time at which the baseline demand profile 100 would have reached the peak value P_{max-baseline}.

In one example, the parameters (e.g., start time, end time, duration, temperature set points, etc.) of the pre-cooling period PCP can be defined at a step 1110. In one aspect, the time t₀ at which the peak management period PMP, and thus the pre-cooling period PCP, begins can be established by using the following protocol. In a first step, a second reference peak value P_{beta} is established at step 1208 which can be defined by the peak value P_{max-baseline} minus a second increment x₂. The second reference peak value P_{beta} may also be defined as a function of the first reference peak value Pₐₗₚₕₐ or as a function of some other parameter. The second increment x₂ that defines the second reference peak value P_{beta} may be established by a number of approaches. For example, x₂ can be set as a fixed value, can be set as a fraction or some other function of the peak value Pₘₐₓ, or via another method. In the example presented herein, the second increment x₂ is a fixed value set at 20 kW. In one aspect, the actual performance of the policy can be fed back into the trained model to optimize the selected value for the second increment x₂ for subsequent implementations of the policy. The time t1 can be identified as the time at which the baseline demand profile 100 first intersects the second reference peak value P_{beta}. The start time t₀ of the pre-cooling period PCP can then be established by subtracting a first time increment tₓ from the time t₁. The start time t₀ may also be defined as a function of some other parameter. The first time increment tₓ may be established by a number of approaches. For example, tₓ can be set as a fixed value, can be set as some other function of the time t₁, or via another method based on other considerations, as described below. In the example presented herein, the first time increment tₓ is a fixed value set at 2 hours. In one aspect, the actual performance of the policy can be fed back into the trained model to optimize the selected value for the first time increment tₓ for subsequent implementations of the policy. Referring to Figure X, it can be seen that a precooling period portion 110a of the actual demand power profile 110 increases at a greater rate in comparison to the baseline demand profile 100 during the precooling period (PCP) as would be anticipated by the additional cooling load demanded by the lowered set points T_{pc}. In one example, the pre-cooling period PCP ends at time t₁ which is the originally predicted where baseline demand profile 100 first intersects the second reference peak value P_{beta}.

In one example, the parameters (e.g., start time, end time, duration, temperature set points, etc.) of the drift period DP can be defined at a step 1112. In one example, the drift period DP commences starting at time t₁ whereby the HVAC system temperature set points are returned to the normal operating temperature set point Tₙₒ until time t₂. As the HVAC system cooled the zones to a temperature that is well below the normal operating temperature set point Tₙₒ during the precooling period PCP, cooling in the drift period DP is provided at a diminished rate by the selected units in the HVAC system until the zone temperatures gradually climb up to the normal operating temperature set point Tₙₒ. The selected units of the HVAC system will operate to maintain the normal operating temperature set point Tₙₒ until the end of the drift period DP and the commencement of the curtailment period CP at time t₂. Referring to FIG. 4, it can be seen that a drift period portion 110b of the actual demand power profile 110 increases at a lower rate in comparison to the baseline demand profile 100 during the drift period (DP) as would be anticipated by the reduced cooling load demanded by the increased set points T₀. In one aspect, the drift period DP ends at time t₂.

In one example, the parameters (e.g., start time, end time, duration, temperature set points, etc.) of the curtailment period CP can be defined at a step 1114. In the example presented herein, the curtailment period CP starts at time t₂, which coincides with the time which the baseline demand profile 100 reaches the peak value P_{max-baseline}. At this point, the HVAC system temperature set points are updated with the curtailment period set point T_{c}, which is higher than the normal operating temperature set point Tₙₒ, until time t₃. As the HVAC system cooled the zones to a temperature that is well below the curtailment period set point T_{c} during the drift period DP, cooling in the curtailment period CP is provided at a diminished rate by the selected units in the HVAC system until the zone temperatures gradually climb up to the curtailment period set point T_{c}. The selected units of the HVAC system will operate to maintain the curtailment period set point T_{c} until the end of the curtailment period CP at time t₃. In one aspect, time t₃ is set to be the second time at which the baseline demand profile 100 intersects the second reference peak value P_{beta}. Once time time t₃ is reached, the policy ends and the HVAC system is returned to normal operation whereby the temperature set point is returned back to the normal operating temperature set point Tₙₒ. Referring to FIG. 4, it can be seen that a curtailment period portion 110c of the actual demand power profile 110 increases at a lower rate in comparison to the baseline demand profile 100 during the curtailment period (CP) as would be anticipated by the reduced cooling load demanded by the increased set points T_{c}.

Once the parameters of the periods PCP, DP, CP have been defined, the policy can be generated at a step 1116 and subsequently implemented, as described below.

The policy generation process 1100 can include additional or alternative steps for creating a policy. For example, the times at which the periods PCP, DP, and CP begin and/or end could be instead based on active variables such as thresholds associated with the actual measured space temperature or on the actual measured peak consumption of the associated air handling equipment. Switching from one period to another could also be based on an achieved condition(s), such as all zones reaching a specified temperature set point or the peak electrical demand of the entire building reaching a certain number relative to the peak electrical demand value P_{max-baseline}.

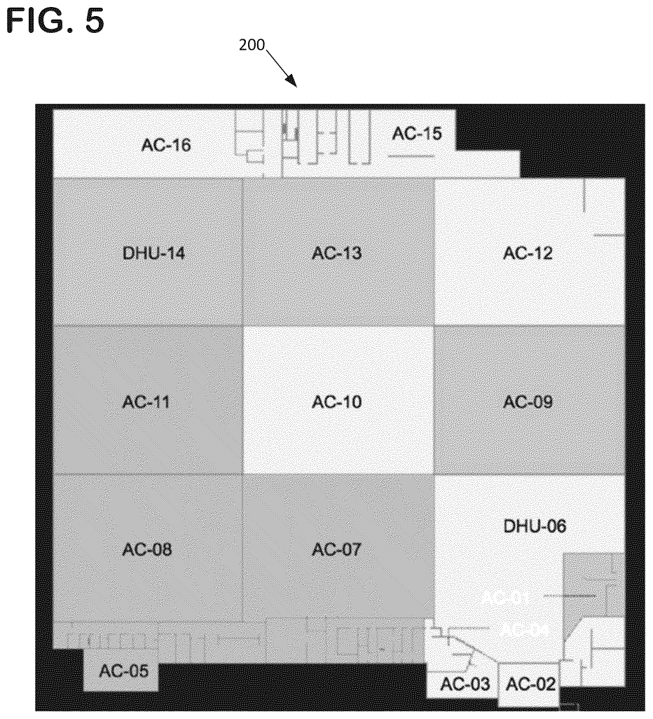

Referring to FIG. 5, a building floor layout for a retail store 200 is shown that is divided into multiple temperature control zones (AC-02, AC-03, AC-05, DHU-06, AC-7 to AC-13, DHU-14, AC-15, and AC-16) associated with an air conditioning system. In some examples, one or more air handling units (e.g., a roof-top unit RTU) serve each zone to maintain a desired temperature set point in that zone. In such cases, a temperature sensor is provided for each zone and the RTU controller and/or the building automation system is programmed with a temperature set point. The RTU controller then cycles the fan, compressors, and/or burners as needed to maintain the zone temperature at the temperature set point. The aforementioned policy temporarily replaces these normal operating temperature set points as a means for indirectly controlling the cycling of the compressors of the RTU's.

As depicted, zones AC-07, AC-10, and AC-13 are interior zones with no exterior walls (not counting the roof) while the remaining zones include at least one exterior wall. As such, the cooling load profile for the interior zones is likely to be different from the cooling load profile for the exterior zones as the exterior zones have more exposure to external temperature and solar loads in comparison to the interior zones. As such, in some examples, it may be desirable to generate multiple policies customized for each individual zone or RTU or for groups of zones and RTU's with similar loading profiles. In such an implementation, a selected number of RTU's could be operated under a first policy (e.g., RTU's associated with AC-07, AC-10, AC013) while the others could be operated under a second policy. The first and second (or more) policies can include different parameters for temperature set points, start and end times, and/or different peak reference values. It is also possible to only implement policies with respect to some RTU's and not others, thus allowing a portion of the system to remain in normal operation while another portion is operating under the rules of the policy. The policy could also include instructions for rotating the RTU's that are under control of the policy at any given time.

In one example approach, the baseline electrical demand profile 100 generated by the model can be disaggregated into multiple profiles 100 relating to the building zones or groups of zone in order to generate multiple policies. For example, the baseline electrical demand profile 100 can be divided into a first group including the most used sales floor RTU's and a second group including the least used sales floor RTUs. A policy can then be generated which implements the pre-cooling phase PCP with the group including the least used RTU's and can then subsequently implement the curtailment phase CP with the group including the most used RTU's. In one aspect, this approach can be optimized by characterizing the area defined between the baseline peak demand profile 100 and the Pₐₗₚₕₐ line as the energy shifting potential for the target day. From that, the rate of change of energy consumption can be calculated using the gradient of the baseline demand profile 100 from time t₁ and a given increment before time t₁ (e.g., 4 hours before time t₁). This energy shifting potential can then be divided by the cooling or compressor capacity of the first group of RTU's to determine the number of hours for precooling required for the store, thereby providing an alternative approach for defining time t₀.

Although the term “RTU” is used herein, it should be understood that this is only one example of many types of air conditioning systems that could be used in conjunction with the disclosure. For example, non-limiting examples of systems for which the policy can be implemented are interior or exterior air handling units served by a central chiller plant, split-system units, and heat pump systems. Many other implementations are possible without departing from the concepts presented herein.

### Policy Implementation 1200

In generalized terms, and with reference to FIG. 3, the generated peak electrical demand value P_{max-baseline} for the target day can be used to predict if the occurrence of a new peak electrical demand day may occur in a process 1200. The model can make this determination by retrieving the baseline electrical demand profile 100 for the target day at step 1500, identifying the peak electrical demand value P_{max-baseline} for the target day at step 1204, identifying the maximum electrical demand-to-date value within the current billing period at step 1206, and by comparing the peak electrical demand value P_{max-baseline} to the maximum demand-to-date value at step 1208. Where the peak electrical demand value P_{max-baseline} is predicted to be greater than the actual measured peak electrical demand for all past dates in the demand billing period, the policy can be implemented starting at time t₀ at step 1210 to curtail electrical demand for the target day or specified time period. Where the peak electrical demand value P_{max-baseline} is predicted to be less than the actual measured peak electrical demand for any past date in the demand billing period, the policy need not be implemented at step 1212 on the target day or specified time period as no demand billing savings would be expected to occur. The policy can be terminated at time t₃ at step 1216 whereby the system can be returned to normal operation. In one aspect, the control system can collect data at step 1218 regarding the actual demand profile 110 (e.g., the peak demand savings that occurred) and integrates this data into the model to improve the model and the subsequently generated policy for subsequent implementations. With such an approach, the model and policy can be improved in an iterative process without requiring more complex algorithms involved with real time control. However, the control system can be configured to collect data regarding the actual demand profile 110 during the implementation of the policy and to then modify the policy currently in effect to improve the performance of the policy in real time at step 1218.

### Further Examples

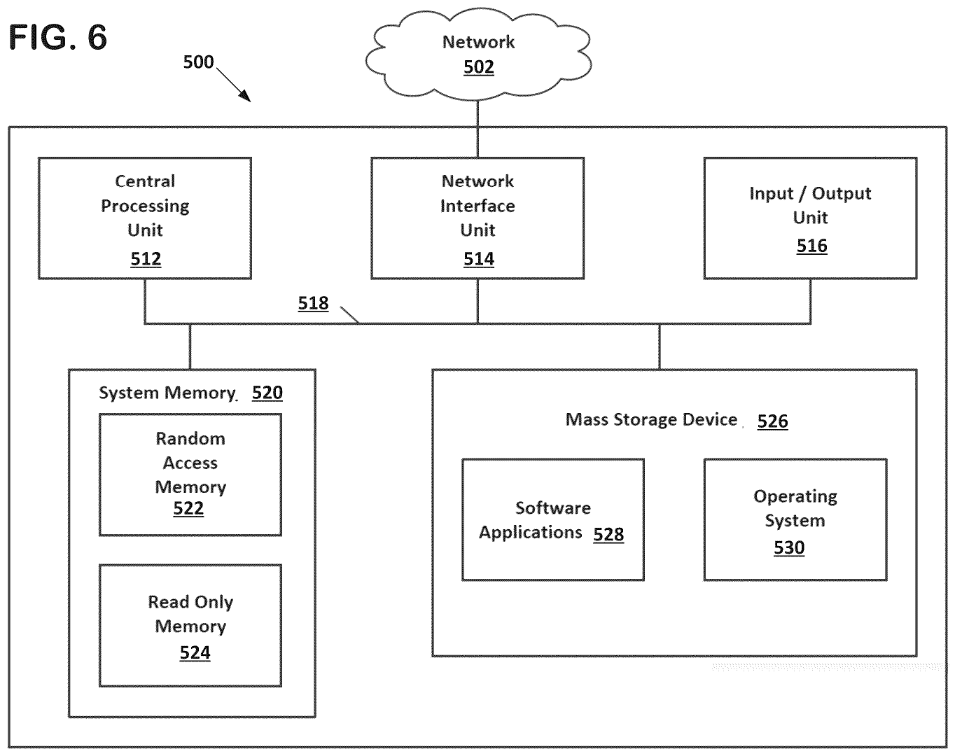

Referring to FIGS. 6-12, a process 2000 that is a variation of the above-described modelling, training, and policy implementation method is presented that can further reduce energy costs through additional strategies that can be implemented across a plurality of facilities to result in aggregated savings. In some examples the plurality of facilities include retail stores. In one aspect, the process 2000 accurately estimates energy requirements at each of a plurality of stores during various time points, and then passes the estimates to an optimization scheduler, which will recommend the optimal appliances activity, so that, the energy cost is minimized without disrupting the business constraints, while simultaneously maintaining various given metric thresholds at each stores. In one aspect, process 2000 can be configured as a scalable, real-time, comprehensive, accurate, and simple to integrate product.

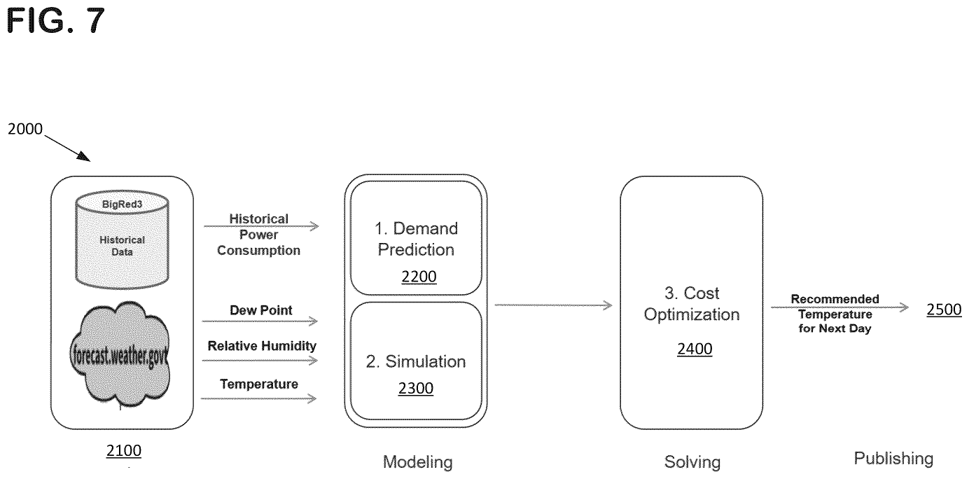

As shown in FIG. 7, process 2000 can include a data collection step 2100, a demand prediction step 2200, a simulation step 2300, a cost optimization step 2400, and a publishing and implementation step 2500. In data collection step 2100, data like historical power consumption and weather forecast information is collected. In some implementations, data collection step 2100 generally involves the same steps as steps 1002, 1004, and 1006. Accordingly, the description for steps 1002, 1004, 1006 is applicable for data collection step 1600 and need not be repeated in this section. The demand prediction step 2200, simulation step 2300, and cost optimization steps 2400 can be integrated aspects of the above-described policy generation process 1100 and used to optimize parameters discussed above with respect to process 1100. For example, steps 2200, 2300, and 2400 can be utilized to optimize the pre-cooling phase to further reduce energy consumption and costs. Publishing and implementation step 2500 can also be utilized to supplement process 1100 and policy implementation process 1200. Alternatively, process 2000 can be implemented as a stand-alone process independent of processes 1000, 1100, and 1200 in which other data collection and demand prediction methodologies are utilized for peak management.

In demand prediction step 2200, a supervised machine learning module is utilized to, based on information gained in data collection step 2100, predict the energy required to maintain and indoor temperature setpoint over increments of time through a specified time period. In some examples, the supervised machine learning module is an extreme gradient boosting model (‘XGBoost’) which is a scalable, distributed gradient-boosted decision tree (GBDT) machine learning library that provides for parallel tree boosting usable with regression, classification, and ranking problems. By using such a module, electrical power consumption can be determined for each specified time increment in which a starting indoor temperature and an ending indoor temperature are identified.

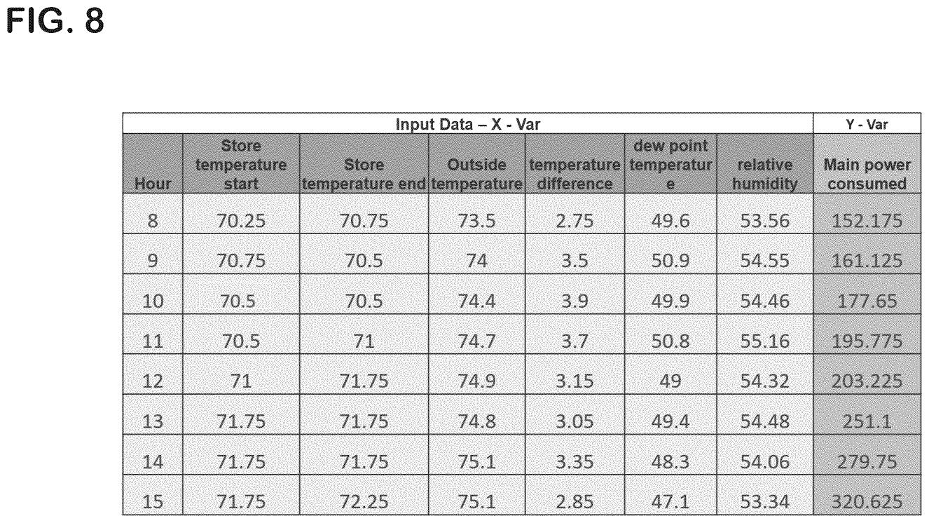

FIG. 8 shows an example set of calculations relating to an interior space served by one or more air handling units (e.g., an RTU or group of RTUs) in which one hour increments of time and an initial starting temperature of 70.25 is utilized, wherein a main power consumption in kwh is determined for each time increment. As shown, for each subsequent time increment, the starting temperature is the ending temperature of the previous time increment. Of note, it can be observed that the energy consumption associated with maintaining even the same temperature can increase over time due to increased external and/or internal loading of the system. With such a model, various iterations can be run utilizing different starting indoor temperatures and temperature setpoints throughout the day. Demand prediction step 2200 can also include applying an electrical rate to the calculated energy consumption to additionally return an electrical cost associated with each time increment and iteration.

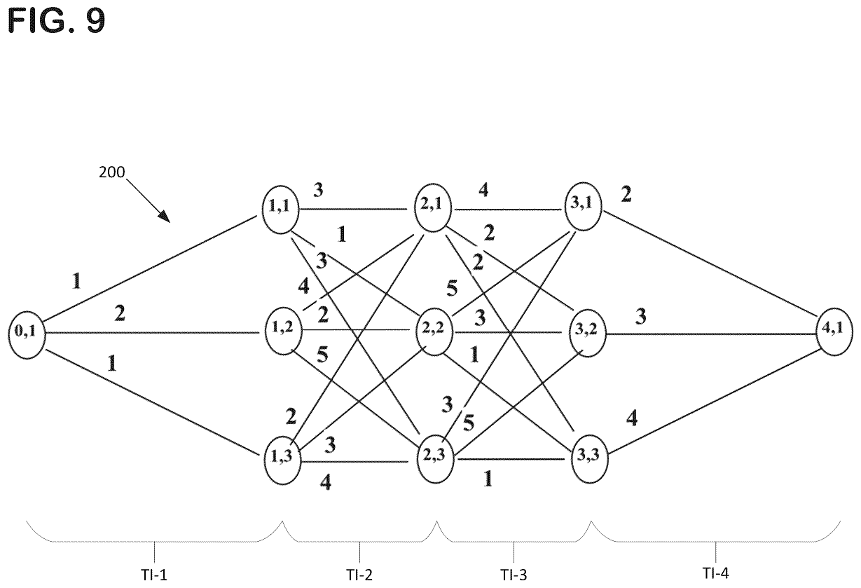

Simulation step 2300 includes running various predictive iterations or scenarios with the model for every feasible store temperature setting for the following day. Based on available temperature ranges, all possible flows from one state to another can be calculated such that the cost to transition between temperatures from one time increment to another can be identified. In some examples, a least cost path or optimal path from these flows can be determined via a dynamic programming function. Alternatively, a mixed integer approach can be utilized. Referring to FIG. 9, a visualization of a dynamic programming model or function 200 is presented in which 0,1 represents a starting hour and 4,1 represents an ending hour. Between these two points, four time increments TI-1 to TI-4 exist in which each includes three example optional nodes. In some examples, and as discussed further below, each node can represent a different temperature for a interior space or zone. In such an example, each path denotes the cost incurred from moving from a stage to another stage. For example, the path denoted as 3 from node 1,1 to node 2,2 symbolizes the cost incurred if the choice is made to move to the second choice temperature at hour 2 from the first choice at hour 1.

In some examples, the machine learning algorithm utilizes past collected data to aid in the determination of the energy costs from one node to another. In some examples, a function approximator is utilized to estimate the relationships between the temperature control performance with input as current state of temperature and external conditions as factor. The output of the function is the HVAC power function which also serves as the reward of the system. In some examples, a data provisioning (DP) agent can be utilized to examine all the possible paths among various states and to select the optimal path starting from the first hour to the last power under investigation, and selects the optimal path on which the power consumption (or cost of power consumption, if cost data is provided) is minimum.

To implement such an approach, several considerations are noted. States (s): The temperature of the store is considered as a state. Every hour (t), the temperature of the stores moves from the current state to another state, subject to the state respects the boundary constraints or any other business constraints. Action (a): The temperature difference control is the action performed on the state, to make the temperature or the store in the next hour move to next temperature state, without violating the constraints even in next state space. Reward (r): The total power consumed to perform the state change is estimated by the function approximator(f) as explained in the flow diagram. It takes into input the current state of store temperature, the temperature difference action to be taken, external factors like weather, time of month and so on. We will further continue to finetune this function for better fit of function approximation. Discount Factors (y): Each of the hourly power estimators are multiplied by the discount factors to give the reward function in terms of money consumption. This is minimized over all the hourly paths, and the best minimal path in terms of the total money consumed is chosen as the optimal path, and hence the best recommended temperature points are output over all the hours. Transition Table (7): All states which are within the constraints are equally likely to move from any state. With the above taken into consideration, a data provisioning equation can be established as:

$$DP ( {s}_{t} , t ) = {min}_{Δ t ∈ A} ( {\sum }_{t ∈ T} f ( {s}_{t - 1} , Δ t , … ) + DP ( {s}_{t - 1} , t - 1 ) )$$

$$Where , A : set of actions or viable temperature differences , Δ t ∈ A$$

$${s}_{t} : State at time t , i . e . , store temperature at time t$$

$$T : set of all time spaces on which the experiment if performed t ∈ T$$

$$f : Function Approximator$$

$$DP : The Dynamic Programming Function which chooses the best optimal path$$

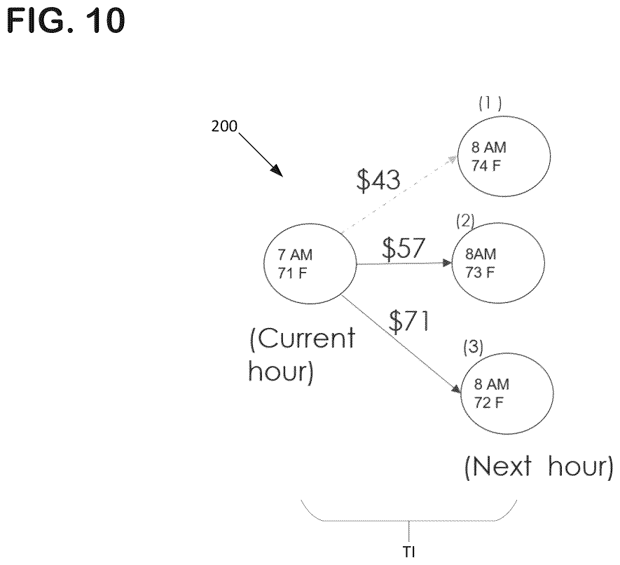

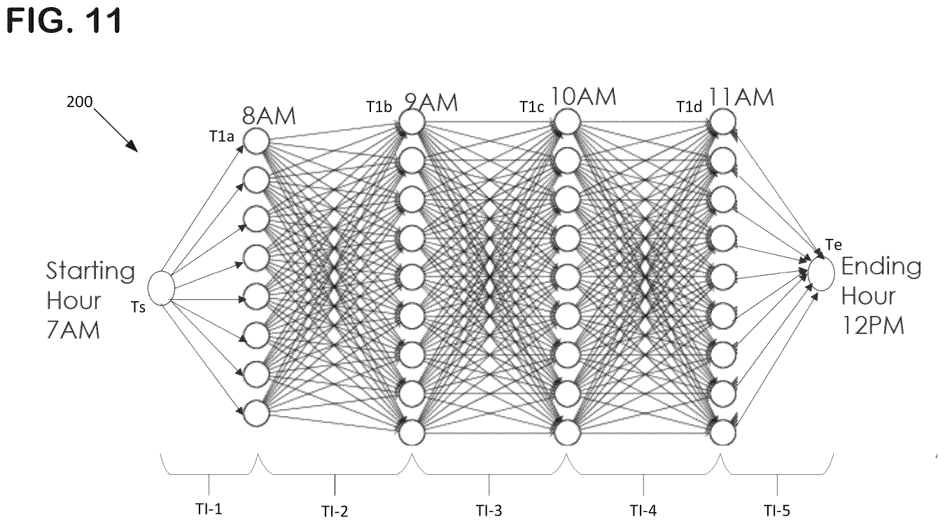

To further illustrate the above concept, as applied to a building temperature control system, FIG. 10 shows a schematic example in which three scenarios for a one hour time increment TI are calculated starting from an initial indoor temperature of 71 F (degrees Fahrenheit) at 7 AM. In such an example, there is a load on the space such that the RTU(s) must utilize air conditioning compressors to maintain the current temperature. As can be seen at FIG. 10, the predicted cost associated with allowing the temperature to rise to 74 F is about $43, the predicted cost associated with allowing the temperature to rise to 73 F is about $57, and the predicted cost associated with allowing the temperature to rise only to 72 F is about $71. FIG. 11 shows an extrapolation of this concept in which a plurality of starting and ending temperatures are utilized for each time increment between the starting and ending temperatures over five time increments, TI-1 to TI-5. As shown, costs for eight different ending temperatures T1a are calculated for time increment TI-1, and nine different ending temperatures T1b, T1c, T1d are calculated for time increments TI-2 to TI-4, respectively. For time increment TI-5, costs to bring the ending temperature Te from the nine ending temperatures T1d associated with time increment TI-4 are calculated. In the example shown, 44 total cost increments are calculated over the total time period. Although FIG. 11 shows a starting time of 7 AM, an ending time of 12 PM and five one hour time increments, step 2400 can include utilizing any number and size of time increments over any particular period. For example, the total time period can be the same as described in association with any or all of the phases shown at FIG. 4, including the peak management period PMP, precooling phase PCP, drift phase DP, and/or the curtailment period CP. In some examples, the time increments can be 15 minutes or less, 30 minutes, 1 hour, and/or 2 hours or more. Further, the time increments be different from each other over the total time period. For example, shorter time increments can be utilized over durations where relatively large load changes are anticipated to occur while longer time increments can be utilized over durations where load changes are expected to remain relatively constant. Advantageously, and based on experiments with production data, it has been observed that temperature set points selected by the algorithm do not exhibit significant changes between consecutive hours. When all possible temperature combinations are graphed, larger jumps inherently incur higher costs. As a result, the model is less likely to select these larger jumps, effectively preventing them and reducing or eliminating the chance that implementation of the algorithm would result in an undesirable electrical demand spike during a peak management period.

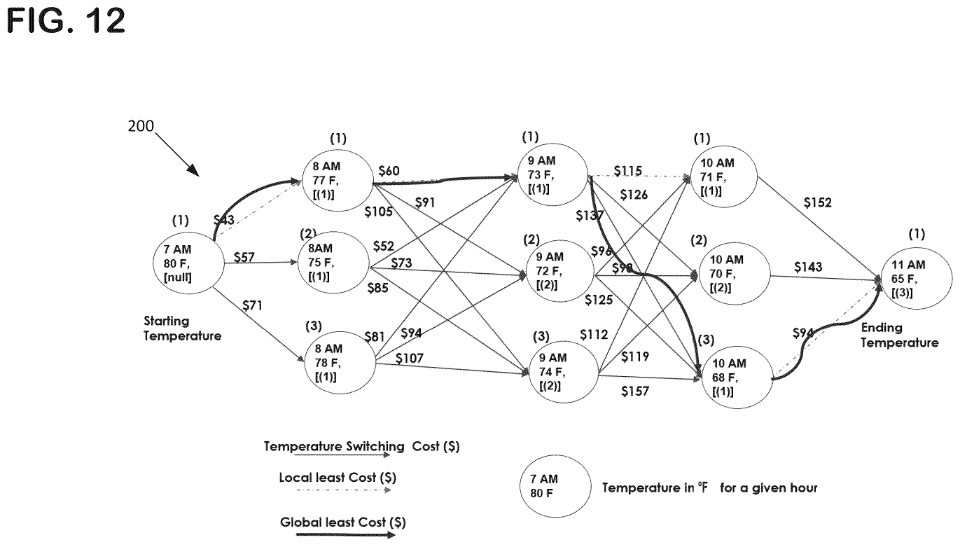

Once the calculations associated with the simulation step 2300 are complete, the cost optimization step 2400 can be performed. In this step, the simulation data can be utilized to create a graph which is in turn utilized by a shortest path algorithm solver using dynamic programming to calculate the optimal least energy-cost path to control the building from the starting temperature Ts to the ending temperature Te. To illustrate, FIG. 12 shows a simplified diagram in which energy costs for three different temperatures are calculated for each time increment over four time increments during a precooling phase PCP in which the initial temperature is lowered from 80 F to 65F. As shown, the system can identify that the least cost pathway is one in which the temperature is lowered from 80 F to 77 F over the first time increment, lowered to 73 F over the second time increment, lowered to 68 F during the third time increment, and lowered to 65 F during the fourth time increment. In the illustrative example, this pathway leads to a total predicted cost of $334 which represents a measurable energy and cost savings over a more simple approach in which the temperature set point is simply changed from 80 F to 65 F and the system resultantly drives down the temperature as quickly as possible. For example, the pathway in FIG. 12 which follows the fastest possible temperature drop (e.g., 80F to 75F to 72F to 68F to 65F), which is still a controlled pathway using the disclosed approach, has an associated cost of $349 which is about five percent greater than the above-described least cost path. FIG. 12 also illustrates that the ‘local least cost’, which is the lowest calculated cost between two time increments, is not necessarily within the pathway that will lead to the total or global least cost. It is also noted that the energy cost per kilowatt hour can be changed for each time increment to reflect utility rate changes if they happen to be variable throughout the day.

Once the above least cost pathway has been determined for each zone and/or RTU in a building, the system can publish a temperature set point schedule for each zone and/or RTU, for use by the building automation system, which includes a specified temperature setpoint for each defined time increment throughout a specified control period. For example, an example published schedule could be as shown in the below table:

Temperature Setpoint Schedule

| | |
|---|---|
| 12:00 AM-6:59 AM | 80 F. |
| 7:00 AM | 80 F. |
| 8:00 AM | 77 F. |
| 9:00 AM | 73 F. |
| 10:00 AM | 68 F. |
| 11:00 AM | 65 F. |
| 12:00 PM-8:59 PM | 76 F. |
| 9:00 PM-11:59 PM | 80 F. |

Once scheduled, the RTU can then simply operate to meet each new setpoint that is defined for each subsequent time increment throughout the day. As noted above, simulations can be run for a number of facilities and published schedules can be distributed to those facilities ahead of the next day's operation. In some examples, once the schedule can be published as a script that updates the temperature setpoint for each building and/or RTU at each specified time increment.

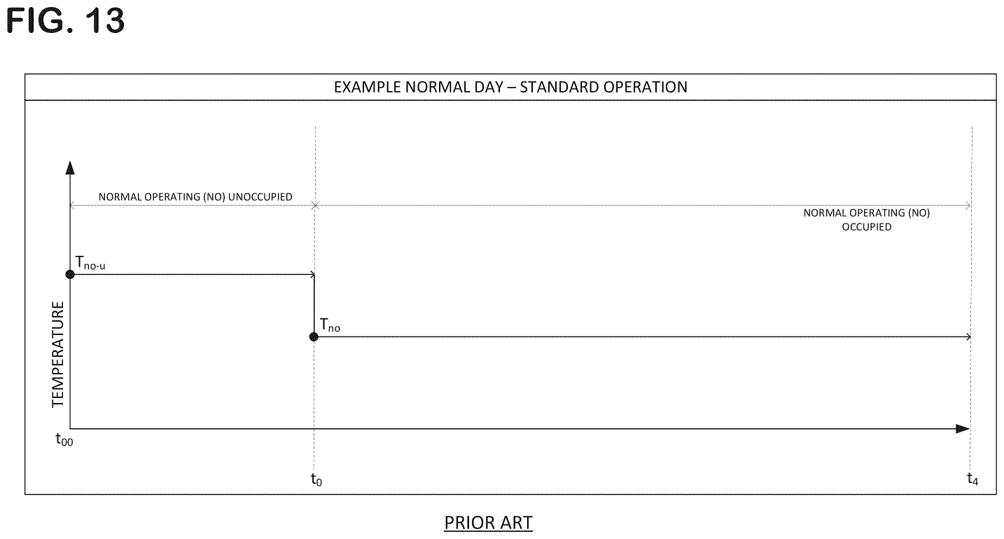

Referring to FIGS. 13 to 15, examples of temperature setpoint scheduling are provided to further illustrate the concepts described above. Each of FIGS. 13 to 15 shows a 24 hour time period starting at the unoccupied period of the building or system which could be, for example, 10 PM. FIG. 13 shows a simple conventional temperature setpoint schedule in which the temperature setpoint is set to Tₙₒ₋ᵤ (unoccupied temperature setpoint) at time t₀₀ (unoccupied period start point). This setpoint remains in place until the beginning the occupied period at time to at which the temperature setpoint is set to Tₙₒ (normal operation temperature setpoint). The setpoint remains at Tₙₒ until the start of the next unoccupied period at time t₄. With such an approach, there are only two temperature setpoints utilized during a 24-hour period. During times when a cooling demand exists (e.g., during summer months) that necessitates air conditioning, as is illustrated, Tₙₒ₋ᵤ would be higher than Tₙₒ to save energy during unoccupied time. For example, Tₙₒ₋ᵤ could be about 78 F while Tₙₒ could be about 72 degrees. The opposite would be the case during times when a heating demand exists (e.g., during winter months).

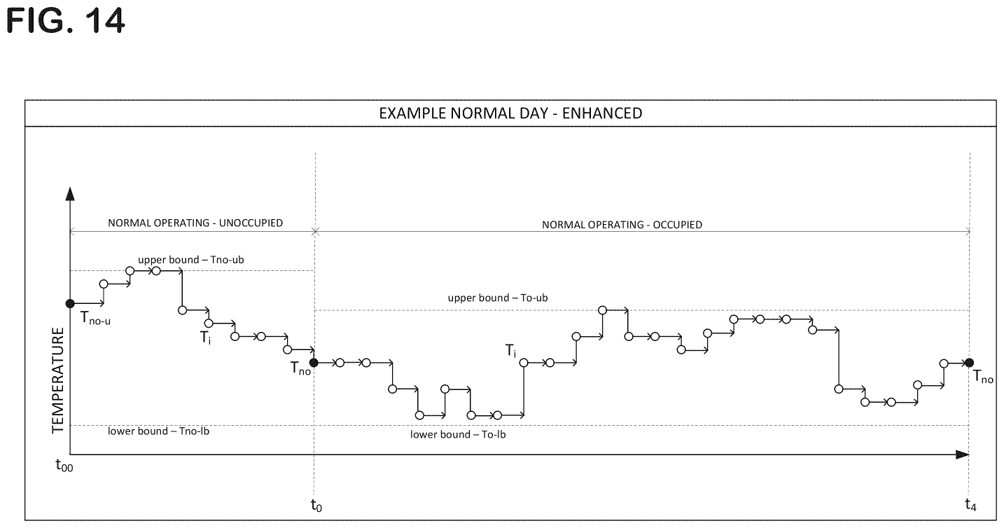

FIG. 14 illustrates a normal operating day utilizing the above-described process 2000. As shown, Tₙₒ₋ᵤ at time t₀₀, Tₙₒ at time t₀, and Tₙₒ at time t₄ are used as anchor points for running the process over two time periods. These times and temperature setpoints can be the same as described above in relation to FIG. 13. For the first time period, which labeled as the normal operating—unoccupied period, Tₙₒ₋ᵤ is used for the starting temperature Tₛ at time t₀₀ while Tₙₒ is used for the ending temperature Tₑ at time t₀. During this time period, upper and lower bounds T_{no-ub}, T_{no-lb} are defined to limit the available selection of possible temperature setpoints for the least cost algorithm to evaluate and choose from. Examples of T_{no-ub} and T_{no-lb} are 80 F and 65 F, respectively. With these parameters in place, the least cost pathway can be determined by the process 2000 and intermediate setpoints generated. For the second time period, which labeled as the normal operating—occupied period, Tₙₒ is used for the starting temperature Tₛ at time t₀ while Tₙₒ is used for the ending temperature Tₑ at time t₄. During this time period, upper and lower bounds Tₒ₋ᵤₚ, T_{o-lb} are defined to limit the available selection of possible temperature setpoints for the least cost algorithm to evaluate and choose from. Examples of T_{o-ub} and T_{o-lb} are 76 F and 68 F, respectively. With these parameters in place, the least cost pathway can be determined for the normal operating—occupied period by the process 2000 and intermediate setpoints generated. Once the setpoints have been determined for the entire day or the desired period, a script can be generated and used to update the temperature setpoints of each building, air handling unit, and/or zone. It is noted that the process 2000 could be limited to the occupied period and a single temperature setpoint used for the unoccupied period. However, it is noted that one advantage of using process 2000 during the unoccupied period is that the process will automatically determine the most cost efficient manner of bringing the building to the occupied temperature setpoint from the unoccupied temperature setpoint.

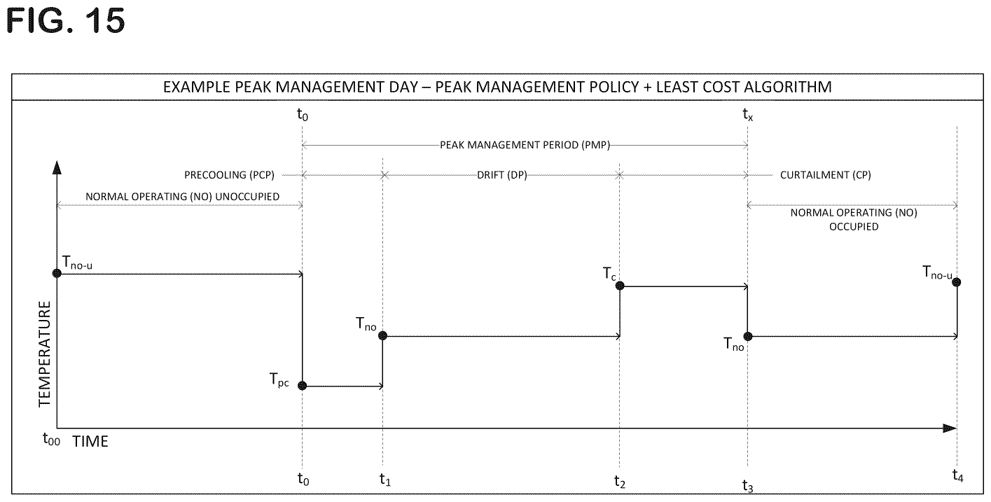

With reference to FIG. 15, a temperature setpoint schedule is illustrated for a peak management day using process 1100. As described previously, a peak management period (PMP) involves multiple different temperature setpoints over precooling period (PCP), a drift period (DP), and a curtailment period (CP). As shown, the temperature setpoints and times for such an application are: Tₙₒ₋ᵤ at time t₀₀, T_{pc} at time t₀, Tₙₒ at time t₁, T_{c} at time t₂, Tₙₒ at time t₃, and Tₙₒ₋ᵤ at time t₄ which respectively relate to the start times for the unoccupied period, precooling period, drift period, curtailment period, normal operating period, and again the unoccupied period.

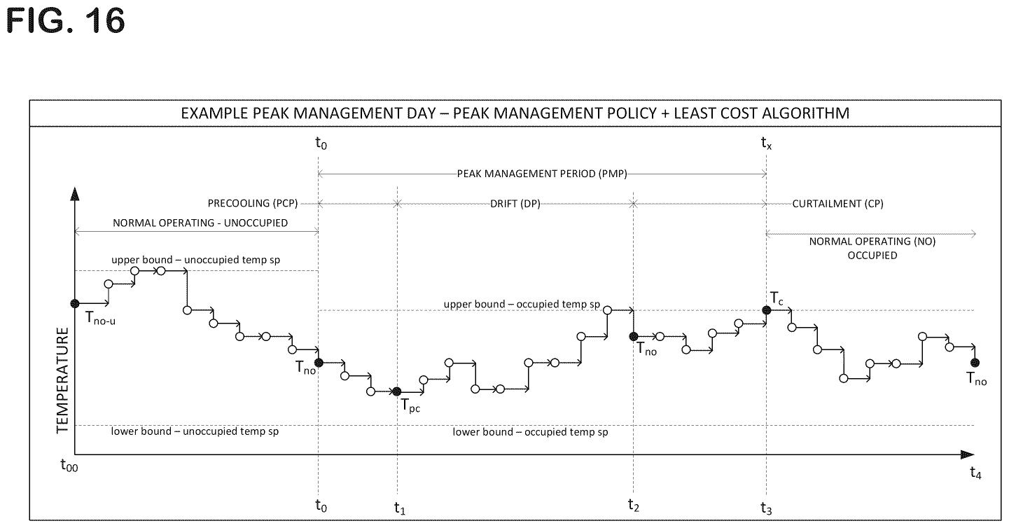

With reference to FIG. 16, a temperature setpoint schedule is illustrated for a peak management day using process 1100 and process 2000 together. With such an application, anchor point temperatures and time periods are defined by process 1100 while process 2000 defines intermediate setpoints between the anchor points, as outlined in the table below.

| | Start | Start | End | End |
|---|---|---|---|---|
| Period | Time | Temp | Time | Temp |
| NORMAL UNOCCUPIED | t00 | Tno-u | t0 | Tno |
| (NO-U | | | | |
| PRECOOLING (PCP) | t0 | Tno | t1 | Tpc |
| DRIFT (DP) | t1 | Tpc | t2 | Tno |
| CURTAILMENT (CP) | t2 | Tno | t3 | Tc |
| NORMAL OCCUPIED (NO- | t3 | Tc | t4 | Tno |
| O) | | | | |

It is noted that with such an approach, process 2000 shifts the temperature setpoints determined by the process 1100 to more efficiently bring the system to the desired temperature at the determined time. This is in contrast to immediately driving the system to different temperature setpoints with potentially sharp jumps in settings. To illustrate, during the precooling period PCP, process 2000 can determine the least cost pathway to bring the system temperature to the precooling temperature setpoint T_{pc} from either the normal operating temperature setpoint Tₙₒ or the unoccupied temperature setpoint Tₙₒ₋ᵤ as the relevant condition for a peak management period is to have the building or zone brought to the temperature T_{pc} at time t₁.

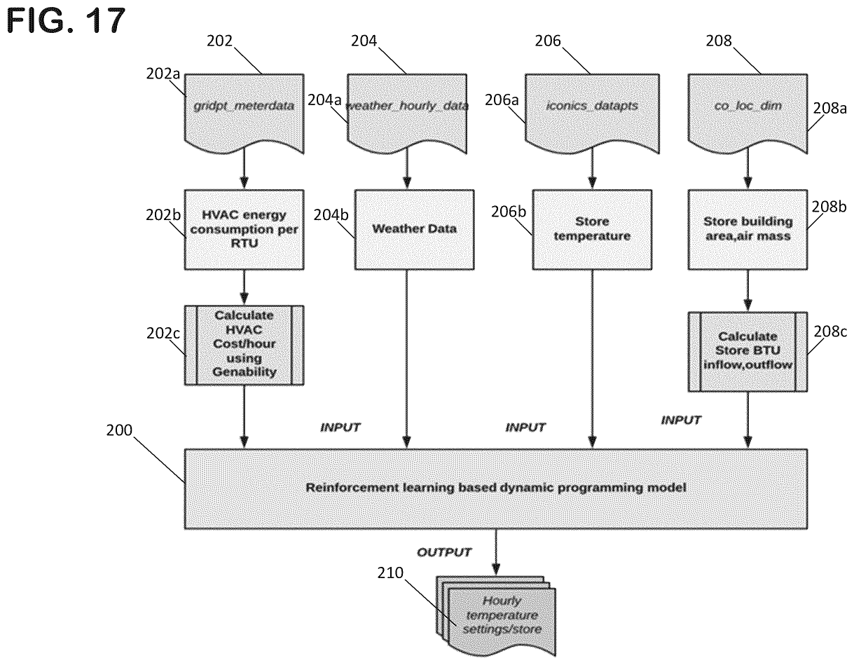

FIG. 17 shows a schematic of a data pipeline that can be used with the above-described approach. As illustrated, the dynamic programming model 200 is provided with data from four input channels 202, 204, 206, 208. In a first channel 202, energy meter data 202a is utilized by an algorithm at 202b to calculate energy consumption per air handling unit or RTU which is in turn used at 202c to calculate a cost per hour of the air handling unit or RTU. In a second channel 204, hourly weather data from a weather source 204a is stored at 204b. In a third channel 206, building temperature data temperature is obtained from a source 206a and stored at 206b. In a fourth channel 208, building data from a source 208a is stored at 208b and is then used at 208c to calculate store energy consumption. Building data can include building area and internal air mass. The calculations at 208c can also be based on data associated with the other channels such as weather forecast data, as described previously. With data from these four input channels, the dynamic programing model 200 can generate the temperature setpoints throughout the design day or period in accordance with the above and generate an output script 210 which can then be used to update air handling unit/RTU setpoints over the period.

### Computing System

Referring now to FIG. 6, an example block diagram of a computing system 500 is shown that is useable to implement aspects of the model and policy of FIGS. 1-4. In the embodiment shown, the computing system 500 includes at least one central processing unit (“CPU”) 512, a system memory 520, and a system bus 518 that couples the system memory 520 to the CPU 512. The system memory 520 includes a random access memory (“RAM”) 522 and a read-only memory (“ROM”) 524. A basic input/output system that contains the basic routines that help to transfer information between elements within the computing system 500, such as during startup, is stored in the ROM 1024. The computing system 500 further includes a mass storage device 526. The mass storage device 526 is able to store software instructions and data.

The mass storage device 526 is connected to the CPU 512 through a mass storage controller (not shown) connected to the system bus 518. The mass storage device 526 and its associated computer-readable storage media provide non-volatile, non-transitory data storage for the computing system 500. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 512 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 500.

According to various embodiments of the invention, the computing system 500 may operate in a networked environment using logical connections to remote network devices through a network 502, such as a wireless network, the Internet, or another type of network. The computing system 500 may connect to the network 502 through a network interface unit 514 connected to the system bus 518. It should be appreciated that the network interface unit 514 may also be utilized to connect to other types of networks and remote computing systems. The computing system 500 also includes an input/output unit 516 for receiving and processing input from a number of other devices, including a touch user interface display screen, or another type of input device. Similarly, the input/output unit 516 may provide output to a touch user interface display screen or other type of output device.

As mentioned briefly above, the mass storage device 526 and the RAM 522 of the computing system 500 can store software instructions and data. The software instructions include an operating system 530 suitable for controlling the operation of the computing system 500. The mass storage device 526 and/or the RAM 522 also store software instructions, that when executed by the CPU 512, cause the computing system 500 to provide the functionality discussed in this document. For example, the mass storage device 526 and/or the RAM 522 can store software instructions that, when executed by the CPU 512, cause the computing system 500 to generate the model, train the model, develop the policy, determine whether to implement the policy, to implement the policy, and to perform all other functions described herein, including those described at FIGS. 7 to 14.

### CONCLUSION

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for reducing electrical costs relating to conditioning air in a building with an air handling unit, the method comprising:
a) identifying a starting hour and a corresponding starting temperature;
b) identifying an ending hour and a corresponding ending temperature;
c) identifying a plurality of time increments between the starting hour and the ending hour;
d) for each of the plurality of time increments, identifying a plurality of temperature setpoint nodes;
e) determining a least cost pathway from the starting temperature at the starting hour to the ending temperature at the ending hour across the plurality of temperature setpoint nodes;
f) publishing a temperature setpoint schedule for each time increment based on the temperature setpoint nodes included in the least cost pathway; and
g) operating the air handling unit from the starting hour to the ending hour based on the published temperature setpoint schedule.

2. The method of claim 1, wherein the determining step includes calculating an energy consumption value from each of the setpoint nodes associated with one of the plurality of time increments to each of the setpoint nodes associated with subsequent time increments.

3. The method of claim 2, wherein the determining step includes calculating an energy charge value from each of the setpoint nodes associated with one of the plurality of time increments to each of the setpoint nodes associated with the subsequent time increments.

4. The method of claim 1, wherein steps a) to d) are performed by a dynamic programming model.

5. The method of claim 1, wherein the starting hour and starting temperature and the ending hour and ending temperature are set to coincide with a precooling phase of a peak management period.

6. The method of claim 1, wherein the plurality of temperature setpoint nodes have a lower bound of 65 degrees F. and an upper bound of 80 degrees F.

7. The method of claim 1, wherein the plurality of time increments are each one hour long.

8. The method of claim 1, wherein the plurality of time increments all have the same length.

9. The method of claim 1, wherein at least one of the plurality of time increments has a length that is different than at least one other of the plurality of time increments.

10. The method of claim 1, wherein the number of plurality of temperature setting nodes is the same for each time increment.

11. The method of claim 1, wherein the air handling unit is a roof top unit (RTU).

12. A method for reducing peak electrical demand of a building, the method comprising:
a) generating, prior to the beginning of a target time period, a baseline electrical demand profile over the target time period from a model, the baseline electrical demand profile being a prediction of electrical demand over the target time period using a normal operating temperature set point and using weather forecast data for the target time period;
b) defining a policy including a peak management period based on the baseline electrical demand profile, the peak management period including at least a precooling period having a first temperature set point, a drift period having a second temperature set point different from the first temperature set point, and a curtailment period having a third temperature set point different from the first and second temperature set points;
c) implementing the policy;
d) collecting performance data during implementation of the policy; and
e) optimizing the model for subsequent generations of the baseline electrical demand profile.

13. The method of claim 12, wherein the model is generated from one or more of historical electrical data for the building, weather forecast data, building operating schedules, equipment operating schedules, sales data, and data based on information received from a video camera located in the building.

14. The method of claim 12, wherein the target time period is a 24-hour period.

15. The method of claim 12, wherein for at least one of the pre-cooling, drift, and curtailment periods, the method further includes a least cost determination including:
a) identifying a starting hour and a corresponding starting temperature;
b) identifying an ending hour and a corresponding ending temperature;
c) identifying a plurality of time increments between the starting hour and the ending hour;
d) for each of the plurality of time increments, identifying a plurality of temperature setpoint nodes;
e) determining a least cost pathway from the starting temperature at the starting hour to the ending temperature at the ending hour across the plurality of temperature setpoint nodes; and
f) publishing a temperature setpoint schedule for each time increment based on the temperature setpoint nodes included in the least cost pathway.

16. The method of claim 15, wherein the determining step includes calculating an energy consumption value from each of the setpoint nodes associated with one of the plurality of time increments to each of the setpoint nodes associated with subsequent time increments.

17. The method of claim 16, wherein the determining step includes calculating an energy charge value from each of the setpoint nodes associated with one of the plurality of time increments to each of the setpoint nodes associated with the subsequent time increments.

18. The method of claim 15, wherein the least cost determination is performed for each of the precooling, drift, and curtailment periods.

19. A method for operating an air handling unit of a building over a time period, the method comprising:
a) determining whether to implement a peak management policy or to operate the air handling unit in a normal operating mode;
b) based on the determination, identifying one or more time periods each including a starting temperature setpoint and starting time, an ending setpoint and ending time, and a plurality of intermediate temperature setpoints and associated implementation times; and
c) updating a temperature setpoint setting of the air handling unit in accordance with a script based on the determination step.

20. The method of claim 19, wherein the plurality of intermediate temperature setpoints are determined by a least cost algorithm.
